(19) United States
(12) Patent Application Publication
(10) Pub. No.: US 2026/0084773 A1
(43) Pub. Date: Mar. 26, 2026

(54) Electric Motorcycle

(71) Applicant: Zhejiang CFMOTO Power Co., Ltd., Hangzhou, Zhejiang (CN)

(72) Inventors: Bin Wang, Hangzhou (CN); Luyao Yu, Hangzhou (CN); Xiaobin Qi, Hangzhou (CN); Ye Lin, Hangzhou (CN); Junzhou Zhu, Hangzhou (CN); Mingxi Zhao, Hangzhou (CN)

(21) Appl. No.: 19/404,450

(22) Filed: Dec. 1, 2025

Related U.S. Application Data
(63) Continuation of application No. PCT/CN2023/122295, filed on Sep. 27, 2023.

(30) Foreign Application Priority Data
May 31, 2023 (CN) 202310640423.9

(51) Int. Cl. B62J 43/16; B62J 43/28; B62K 11/04; B62K 25/10; B62K 25/28

(52) U.S. Cl. CPC B62J 43/16; B62J 43/28; B62K 11/04; B62K 25/10; B62K 25/286

(57) ABSTRACT

An electric motorcycle has a battery, an electric motor and an electronic control unit positioned in a receiving space between a main frame and an underframe. The electronic control unit is transversely in line with at least part of the electric motor. A combined width of the electric motor and electronic control unit divided by the maximum frame width is within 0.55-0.75. The maximum main frame width divided by the wheelbase is within 0.08-0.15. The vehicle cover has left and right front half cowls on left and right sides of the head tube, with air cutting outside edges disposed wider than the front shock absorbers and wider than the maximum width of the frame. The battery support system has fixed portions which limit battery movement in five directions and a detachable side strap which limits battery movement in the other sideways direction.

### RELATED APPLICATION INFORMATION

The application is a continuation of PCT/CN2023/122295 entitled “Electric Motorcycle” and filed Sep. 27, 2023, and claims the benefits of priority to Chinese Patent Application No. 202310640423.9, entitled “Electric Motorcycle”, filed with the Chinese Patent Office on May 31, 2023. The entire contents of the above-referenced applications are incorporated herein by reference.

### FIELD OF THE DISCLOSURE

The present application relates to the field of motorcycles, and particularly to an electric motorcycle.

### BACKGROUND OF THE DISCLOSURE

Relative to internal combustion engine motorcycles, electric motorcycles have the advantages of fast acceleration and low noise. However, as core components, the arrangement and location of the battery and electric motor on electric motorcycles affect their off-road performance. The arrangement and location of the battery and electric motor are particularly critical for electric motorcycles intended for the youth market, with smaller-than-adult drivers. Therefore, how to reasonably arrange the battery, the motor, and electronic control unit of the electric motorcycles to ensure the electric motorcycle has excellent off-road performance while being compact in structure, is a problem that needs to be solved in this field.

### SUMMARY OF THE INVENTION

The preferred embodiments of the present disclosure provide electric motorcycles to solve at least one problem existing in the background.

In a first aspect, an electric motorcycle in accordance with the present invention includes a frame, a vehicle cover, wheels, an electric motor, a battery, and an electronic control unit. The frame includes a main frame extending longitudinally and an underframe at least partially positioned below the main frame. The main frame and the underframe jointly define a receiving space between the main frame and the underframe. The vehicle cover at least partially covers the frame. The wheels include a front wheel and a rear wheel jointly supporting the frame through a suspension system. A wheelbase is defined as the distance between the front wheel rotational axis and the rear wheel rotational axis. The electric motor is supported by the frame within the receiving space and provide torque to at least one of the front wheel or the rear wheel. The battery is supported by the frame within the receiving space and provides electrical energy for the motor. The electronic control unit is used for controlling the motor, and is supported by the frame within the receiving space so as to be transversely in line with at least part of the electric motor. The locations of the battery, electric motor and electronic control unit and relative widths of the vehicle are particularly appropriate for an off-road motorcycle directed to a youth market. In particular, a combined width ratio of a combined width of the electric motor and electronic control unit divided by a maximum width of the frame is greater than or equal to 0.55 and less than or equal to 0.75. A frame width ratio of the maximum width of the main frame divided by the wheelbase is greater than or equal to 0.08 and less than or equal to 0.15.

In another aspect, the frame has a head tube, and the main frame extends longitudinally from the main frame. The suspension system includes two front shock absorbers connected to the front wheel which are pivotal about a head tube axis for steering of the front wheel. The vehicle cover has left and right front half cowls on left and right sides of the head tube behind the front shock absorbers. Each of the front half cowls has an air cutting outside edge disposed wider than the front shock absorbers and wider than the maximum width of the frame.

In another aspect, the underframe has a left underframe tube and a right underframe tube. The maximum width of the frame width is defined by the left underframe tube and the right underframe tube, and is larger than the maximum main frame width. A battery support system has fixed portions and a detachable side strap. The fixed portions of the battery support system limit movement of the battery in front, back, up, and down directions, as well as one of left or right directions. The detachable side strap limits movement of the battery in the other of the left or right directions.

The details of one or more embodiments of the present invention are presented in the following figures and description to make these and other features, objectives, and advantages of the present application more concise and understandable.

### BRIEF DESCRIPTION OF THE DRAWINGS

The drawings described herein are intended to provide further understanding of the present invention. The illustrative embodiments and their descriptions are used to explain the present invention but do not constitute undue limitation of the present invention. In the figures:

FIG. 1 is a front left perspective view of a preferred embodiment of an electric motorcycle in accordance with the present invention;

FIG. 2 is a left side view of the electric motorcycle of FIG. 1;

FIG. 3 is a left side view of the electric motorcycle of FIGS. 1 and 2 but not showing the vehicle cover;

FIG. 4 is a rear right perspective view of the electric motorcycle without its vehicle cover of FIG. 3. n enlarged partial view of point A in FIG. 3;

FIG. 5 is an enlarged view of portion 5 of FIG. 4;

FIG. 6 is a left perspective view of the electric motorcycle of FIGS. 1 and 2 without its vehicle cover and also without its battery and battery support system;

FIG. 7 is an enlarged view of portion 7 of FIG. 6;

FIG. 8 is a left perspective view of the electric motorcycle of FIGS. 1 and 2, showing the seat and the tail guard in exploded view;

FIG. 9 is an enlarged view of portion 9 of FIG. 8;

FIG. 10 is a left perspective view of the left front half cowl of the electric motorcycle of FIGS. 1 and 2;

FIG. 11 is a cross-sectional plan view of the left front half cowl of FIG. 10;

FIG. 12 is a left rear perspective view of the electric motorcycle of FIGS. 1 and 2 without showing the seat;

FIG. 13 is an enlarged view of portion 13 of FIG. 12;

FIG. 14 is a rear left perspective view of the electric motorcycle without a seat of FIG. 12, showing the side guards and one of the battery guards in exploded view; and

FIG. 15 is an enlarged view of portion 15 of FIG. 14.

### DETAILED DESCRIPTION

The present invention will be described in detail with reference to the specific embodiment shown in the accompanying drawings with further embodiments discussed, but these embodiments do not limit the present invention. Any structural, methodological, or functional changes made by those of ordinary skill in the art based on these embodiments are included within the scope of protection of the present invention.

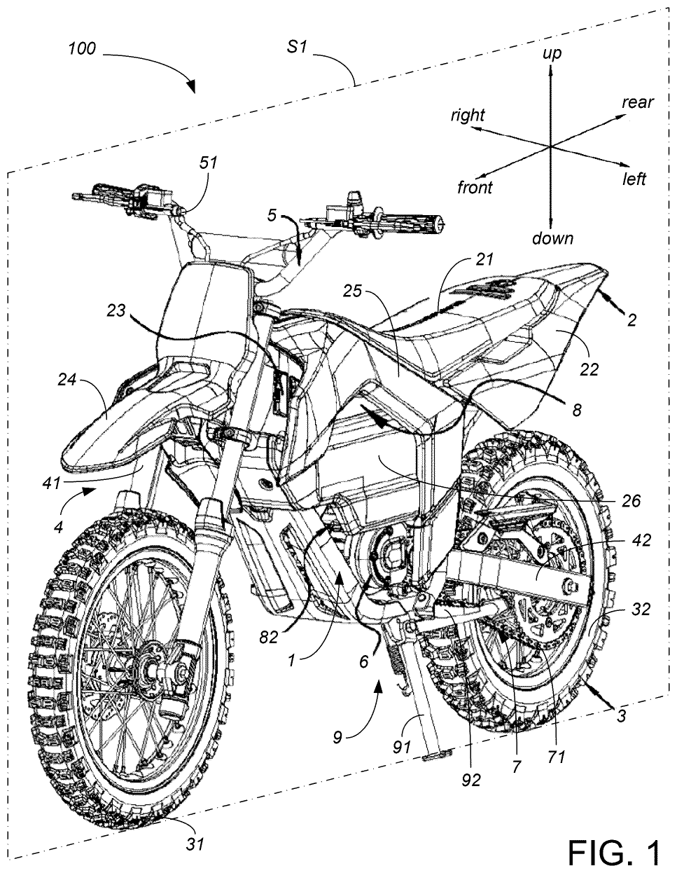

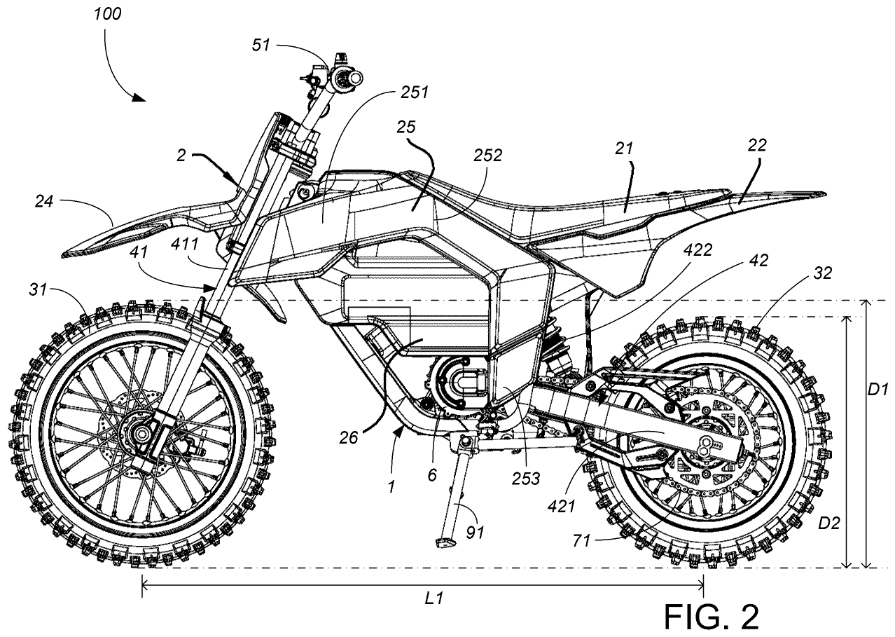

As shown in FIGS. 1 and 2, an electric motorcycle 100 includes a frame 1, a vehicle cover 2, wheels 3, a suspension system 4, a steering system 5, a motor 6, a drive system 7, an electrical system 8 with a battery 81 and an electronic control unit 82, and support components 9. The frame 1 is formed as a generally rigid collection of tubes and/or plates connected together such as by welding and/or fasteners to provide the basic support structure for the other components of the motorcycle 100. The vehicle cover 2 is at least partially mounted on the frame 1 and at least partially covers the frame 1 as well as some other components. The wheels 3 include a front wheel 31 and a rear wheel 32, which support the frame 1 through the suspension system 4. The steering system 5 includes a handlebar 51 which allows operator control over steering of the front wheel 31. The motor 6 provides the torque for locomotion of the motorcycle 100, transferred from the motor 6 to the rear wheel 32 through the drive system 7. The battery 81 is used to supply electric power to the motor 6 and to other components. The electronic control unit 82 is electrically connected to the motor 6 and controls the motor 6. The support components 9 include at least a kickstand 91 used to support the motorcycle 100 upright when parked and footpegs 92 for the driver's feet.

The directions front, rear, left, right, up and down as discussed herein are all as shown in FIG. 1 assuming the motorcycle 100 is upright and on level ground. The motorcycle 100 is substantially bilaterally symmetrical about a longitudinal mid-plane S1. In the present disclosure, the term “outside” means the side of the electric motorcycle 100 or part away from the longitudinal mid-plane S1, while “inside” means toward the longitudinal mid-plane S1.

The kickstand 91 is pivotally connected relatively low in the frame 1, preferably on the left side of the motorcycle 100. In the figures, the kickstand 91 is shown both in its downward position used to support the motorcycle 100 when parked and in its upward positioned for riding of the motorcycle 100. The preferred footpegs 92 are also pivotally connected relatively low in the frame 1, shown in the figures in their downward and outward deployed position for riding of the motorcycle 100.

The electric motorcycle 100 is preferably sized to be driven by a smaller-than-adult youth. Further, the preferred electric motorcycle 100 is intended for off-road use. As will be explained, the motorcycle 100 includes several features which are particularly beneficial for off-road, youth-driven performance.

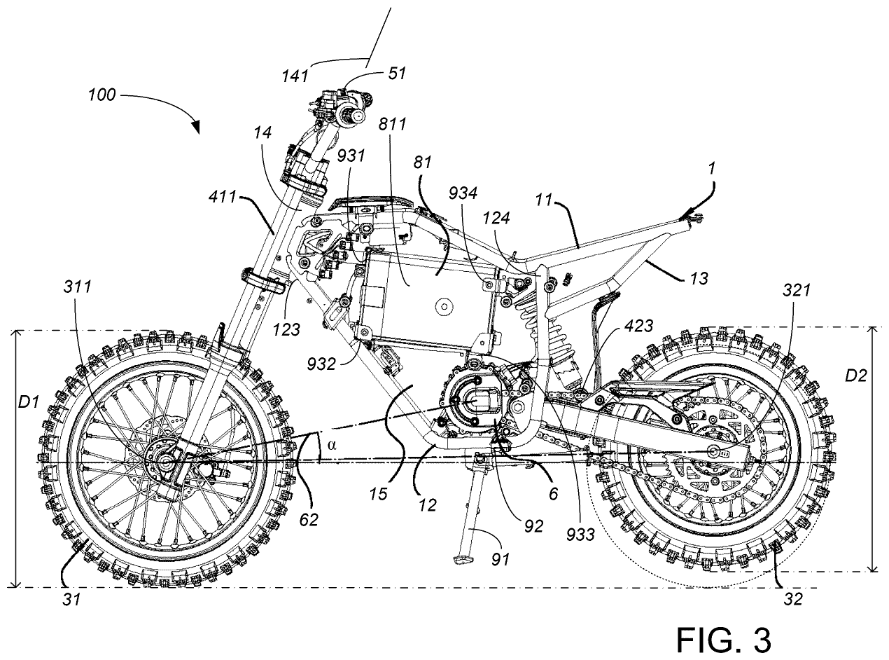

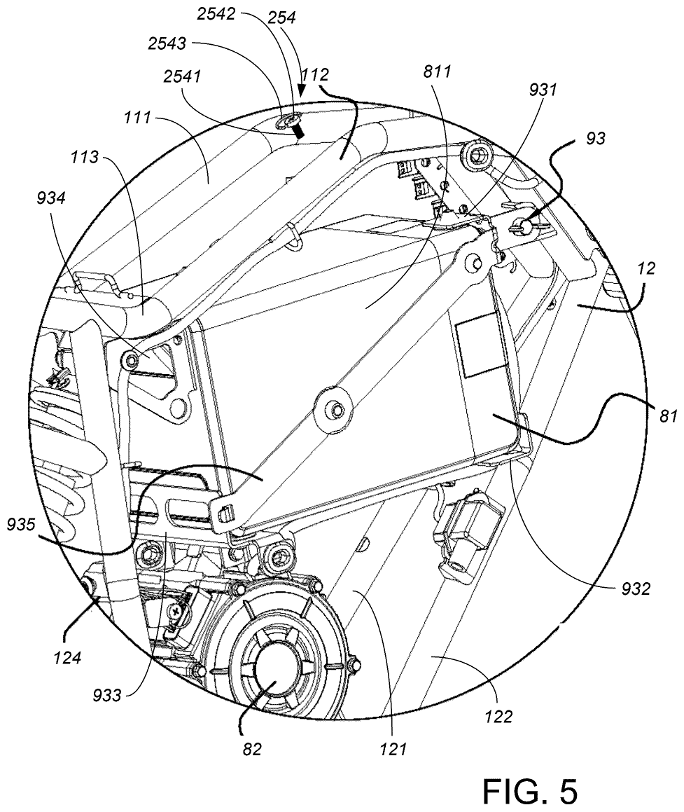

As shown in FIGS. 3-7, the frame 1 includes a main frame 11, an underframe 12, and a tail support 13 all fixedly connected together. The main frame 11, the underframe 12, and the tail support 13 each preferably include keft and right frame tubes 111, 112, 121, 122, 131, 132 positioned on opposing left and right sides of the longitudinal mid-plane S1. The frame 1 further includes a head tube 14, and the front end of the main frame 11 is fixedly connected to the head tube 14 so as to extend generally longitudinally behind the head tube 14. The handlebar 51 pivots about the axis 141 of the head tube 14 for steering of the front wheel 31. The front end 123 of the underframe 12 is fixedly connected to the head tube 14, extending downwardly and rearwardly therefrom before curving upwardly to have its rear end 124 fixedly connected in the middle of the main frame 11. Alternatively, the front end 123 of the underframe 12 could be fixedly connected to the front end of the main frame 11 adjacent the head tube 14. The curvature of the underframe 12 relative to the main frame 11 defines a receiving space 15 between the main frame 11 and the underframe 12. A front end of the tail support 13 is connected to the underframe 12, and a rear end of the tail support 13 is connected to the rear end of the main frame 11. The rear portion of the main frame 11, the upper rear portion 124 of the underframe 12, and the tail support 13 cooperatively define a stable triangular structure, thereby enhancing the overall strength of the rear end of the frame 1.

As best shown in FIG. 3, the entireties of the main frame 11, the tail support 13 and the head tube 14 are at elevations higher than the highest extent of the front and rear wheels 31, 32. The underframe 12 extends downwardly to a position behind the front wheel 31 and in front of the rear wheel 32, at an elevation lower than the highest extent of the front and rear wheels 31, 32.

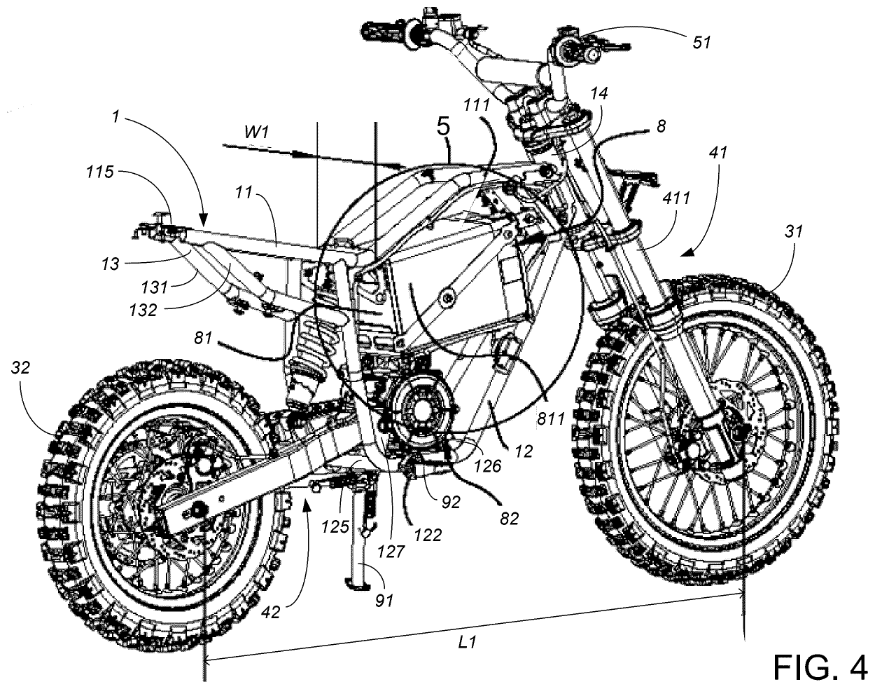

The motorcycle 100 has a wheelbase L1 as shown in FIGS. 2-4, defined as a longitudinal distance between the rotational axis 311 of the front wheel 31 and the rotational axis 321 of the rear wheel 32. Having a relatively long wheelbase L1 allows the vehicle's center of gravity to be lower, improving stability of the motorcycle 100. In general, the frame 1, and particularly the main frame 11, is preferably relatively narrow compared to its wheelbase L1. More specifically, the maximum width of the main frame 11 extending in the left-right direction is defined as the main frame max width W1 as called out in FIG. 4. The main frame max width W1 preferably occurs at a saddle dip 113 of the main frame 11, just in front of where the rear end 123 of the underframe 12 connects to the main frame 11. In the preferred embodiment, a main frame cross tube 114 extends from the left main frame tube 111 to the right main frame tube 112 at the saddle dip 113, such that the main frame max width W1 also occurs at the main frame cross tube 114. A frame width ratio W1/L1 of the main frame max width W1 divided by the wheelbase L1 is preferably greater than or equal to 0.05 and less than or equal to 0.2, more preferably greater than or equal to 0.08 and less than or equal to 0.15, and most preferably greater than or equal to 0.1 and less than or equal to 0.12. Having a frame width ratio W1/L1 within these ranges is particularly beneficial for a youth-sized motorcycle 100, intended to be ridden by smaller-than-adult youths with relatively shorter legs.

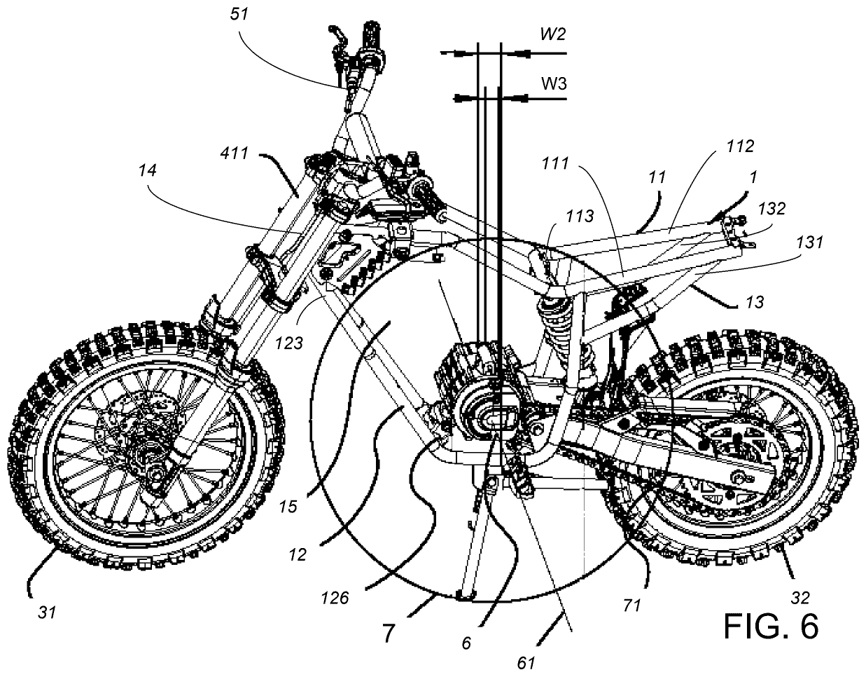

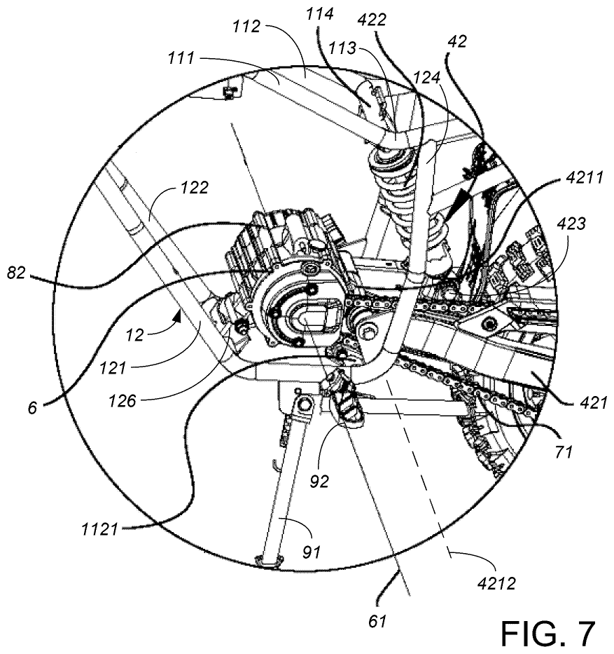

Further, the main frame 11 and the tail support 13 are relatively narrower than the underframe 12, such that the widest portion W2 of the frame 1 (also referred to as “frame max width W2”, called out in FIG. 6) is provided by the underframe 12, at or near where the footpegs 92 attach to the underframe 12. As best shown in FIGS. 4 and 7, a rear underframe cross tube 125 extends from the left underframe tube 121 to the right underframe tube 122 near where the footpegs 92 attach to the underframe 12, such that the frame max width W2 occurs at the rear underframe cross tube 125. The rear underframe cross tube 125 is thus longer than the main frame cross tube 114. The footpegs 92 provide the main support for the rider's feet. When the rider stands and rides, the footpegs 92 substantially support the entire weight of the rider. Having the rear underframe cross tube 125 be longer than the main frame cross tube 114 leads to an overall frame configuration which enables riders, and particularly smaller-than-adult youth riders, to have a more comfortable riding posture when standing and riding, without interference from the wider main frame max width W1 or plastic parts on their legs. In conjunction with the preferred frame width ratio W1/L1, smaller-than-adult drivers can maintain a comfortable riding posture even when standing for a long time while riding off-road.

As shown in FIGS. 3-7, the battery 81, the electronic control unit 82 and the motor 6 are at least partially arranged in the receiving space 15. The electronic control unit 82 and the motor 6 are preferably transversely aligned, in the preferred embodiment with the electronic control unit 82 fixedly connected on the right side of the motor 6. In side view, at least 90% of the motor 6 overlaps with the electronic control unit 82 or at least 90% of the electronic control unit 82 overlaps with the motor 6. Mounting the electronic control unit 82 on the side of the motor 6 provides more space for mounting other components (such as the battery 81) above or in front of the motor 6 within the receiving space 15. Mounting the electronic control unit 82 on the side of the motor 6 also minimizes the length of a wiring harness (not shown) between the electronic control unit 82 and the motor 6, as well as facilitates assembly and maintenance. As called out in FIG. 6, a combined width W3 of the motor 6 and the electronic control unit 82 is preferably no greater than the frame max width W2. More preferably, a combined width ratio W3/W2 of the combined width W3 of the motor 6 and the electronic control unit 82 divided by the frame max width W2 is greater than or equal to 0.5 and less than or equal to 0.9, even preferably greater than or equal to 0.5 and less than or equal to 0.75, and most preferably about 0.6. Having a combined width ratio W3/W2 within these preferred ranges can reserve sufficient space for mounting the drive system 7 while still having a relatively narrow frame 1 for a given wheelbase L1.

The motor 6 is substantially arranged at the lowest and most-rear end of the receiving space 15. Optionally, the underframe 12 includes a front underframe cross tube 126 fixedly extending from the left underframe tube 121 to the right underframe tube 122. The motor 6 is preferably at least partially mounted on the front and rear underframe cross tubes 125, 126, with its output shaft (not shown) extending horizontally and transversely for rotation about a motor shaft axis 61. Other embodiments use a single underframe cross tube or more than two underframe cross tubes. The preferred drive system 7 includes a chain 71 transferring motor torque to the rear wheel 32. Positioning the motor 6 at the bottom rear of the receiving space 15 with its motor shaft axis 61 extending horizontally and transversely effectively shortens required chain length and simplifies chain attachment, achieving greater compactness of the electric motorcycle 100. More specifically, a motor position line 62 can be defined to run between the rotational axis 311 of the front wheel 31 and the motor shaft axis 61. A motor elevation angle α between the motor position line 62 and horizontal (taken when the suspension system 4 is unloaded) is preferably greater than or equal to 10° and less than or equal to 20°, more preferably greater than or equal to 12° and less than or equal to 15°, and most preferably about 13°. A low value for motor elevation angle α allows the motor 6 to be positioned lower and more rearward in the receiving space 15 and closer to the rear wheel 32 for shorter chain length, but too low of a value for motor elevation angle α adversely affects the ability of the motorcycle 100 to clear obstacles. Having a low value for motor elevation angle α also generally lowers the vehicle's center of gravity, improving stability of the motorcycle 100.

The suspension system 4 includes a front suspension 41 for the front wheel 31 and a rear suspension 42 for the rear wheel 32. The front suspension 41 includes left and right front shock absorbers 411. The front shock absorbers 411 turn with the handlebar 51 about the head tube axis 141 of the head tube 14 to turn the front wheel 31 for steering of the motorcycle 100.

The preferred rear suspension 42 includes a rear fork 421 and a rear shock absorber 422. The rear fork 421 is pivotally attached at its front end to the underframe 12 using a rear fork pivot tube 4211 extending between two rear fork mounting ears 127, for pivoting about a rear fork pivot axis 4212 which extends transversely and horizontally just behind the motor 6 and preferably slightly above and forward of the rear underframe cross tube 125. Having the rear fork pivot axis 4212 as close as possible to the motor shaft axis 61 reduces the amount of slack variation of the transmission chain 71 due to loading of the rear suspension 42. The rear fork pivot axis 4212 is preferably slightly lower than the motor shaft axis 61. The rear end of the rear fork 421 is pivotally connected to the rear wheel 32. The rear shock absorber 422 is at least partially positioned behind the motor 6. The upper end of the rear shock absorber 422 is pivotally connected to the main frame cross tube 114, and the lower end of the rear shock absorber 422 is pivotally connected to the rear fork 421 just in front of the rear wheel 32.

The connection point between the rear shock absorber 422 and the rear fork 421 is defined as a suspension connection point 423. When the electric motorcycle 100 is in an unloaded state as shown in FIG. 2 (i.e., with no driver weight, upright and on level ground), the suspension connection point 423 is preferably at about an equal elevation as the motor shaft axis 61. The side view of FIG. 3 shows the position of the rear wheel 32 in an unloaded state in dashed lines. With driver weight added, the rear suspension 42 will load more than the front suspension 41, such as moving the rear wheel 32 to the solid line position shown in FIG. 3. Even with the weight of most youth drivers, the suspension connection point 423 will raise to a slightly higher elevation than the motor shaft axis 61.

As best understood with reference to FIGS. 2 and 3, the preferred embodiment has a front wheel 31 with a front wheel diameter D1 slightly greater than a rear wheel diameter D2 of the rear wheel 32. Having the front wheel diameter D1 slightly greater than the rear wheel diameter D2 significantly improves the obstacle avoidance ability of the electric motorcycle 100 during off-road running.

As shown in FIGS. 3 and 4, the battery 81 is positioned within the receiving space 15 higher than the motor 6 and higher than the electronic control unit 82. The battery 81 is preferably mounted to bisect the longitudinal mid-plane S1, helping to balance the weight of the motorcycle 100 right to left. In plan view, the battery 81 overlaps at least partially with the motor 6 and at least partially with the electronic control unit 82. The battery 81 preferably has a rectangular prism shape, which includes two major sides 811. The two major sides 811 have a larger surface area than the other four sides of the battery 81. In the preferred embodiment, the two major sides 811 of the battery 81 extend longitudinally and vertically. Having the major sides 811 of the battery 81 extend longitudinally and vertically allows for a narrower width of the motorcycle 100. The rear shock absorber 422 is generally positioned behind the battery 81, and in front view the rear shock absorber 422 at least partially overlaps with the battery 81.

The width of the battery 81 is substantially the same as the main frame max width W1, such as extending no more than 10 mm beyond the main frame max width W1. Further, the width of the battery 81 is less than the frame max width W2.

The support structures 9 of the motorcycle 100 include a battery support system 93 further explained with reference to FIGS. 3 and 4. The preferred battery support system 93 includes a front upper abutment corner 931, a front lower abutment corner 932, a rear lower abutment corner 933, a rear abutment 934, and a detachable side strap 935. The front upper abutment corner 931 is fixedly mounted relative to the head tube 14, and contacts a front side and a top side of the battery 81. The front lower abutment corner 932 is fixedly mounted from the underframe 12, and contacts the front side and a bottom side of the battery 81 as well as one of the major sides 811 (in the preferred embodiment, the left major side 811). The rear lower abutment corner 933 is fixedly mounted from a top side of the motor 6 (or motor housing), and contacts the bottom side and a rear side of the battery 81 as well as the (left) major side 811. The rear abutment 934 is fixedly mounted just below the main frame cross tube 114, and contacts the rear side of the battery 81 as well as the (left) major side 811. The side strap 935 is detachably mounted to run from the front upper abutment corner 931 to the rear lower abutment corner 933, contacting the other (right) major side 811 of the battery 81. Each of the abutment corners 931, 932, 933 and the abutment 934 may be welded to the frame 1 or connected to the frame 1 such as by bolted connections. By removing the detachable side strap 935, the battery 81 can be slid laterally to the right, out of the receiving space 15. The abutment corners 931, 932, 933 and abutment 934 effective hold the battery 81 against longitudinal or vertical movement, or movement to the left. Other embodiments may use a different number of abutment corners or abutments, as long as the battery 81 is effectively secured into the receiving space 15 by the battery support system 93. The fixed portions 931, 932, 933, 934 of the battery support system 93 thus limit movement of the battery 81 in the front, back, up, and down directions, as well as one of the left or right directions, while the detachable side strap 935 limits movement of the battery 81 in the other of the left or right directions. The side strap 935 may be connected to the frame 1 and/or other portions of the battery support system 93 by bolts, clamps, or other quick detachable connection methods, as long as they can achieve quick connection and disassembly. This arrangement enables the battery 81 to be quickly disassembled from the frame 1 on one side of the electric motorcycle 100, without disassembling upper structure such as a seat 21.

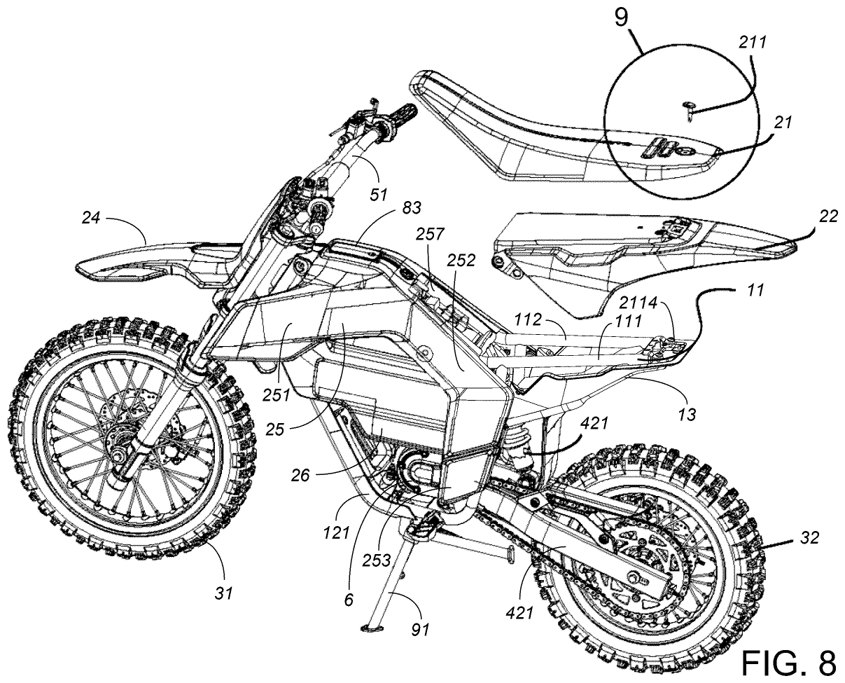

The preferred vehicle cover 2 is further explained with reference to FIGS. 8-15. The vehicle cover 2 includes the seat 21, a tail guard 22, left and right front half cowls 23, a front mud guard 24, left and right side guards 25, and left and right battery guards 26.

A best shown in FIG. 8, the seat 21 is detachably connected so as to cover a portion of the main frame 11 including the saddle dip 113, preferably extending rearwardly to cover all of the main frame 11 rearward of the saddle dip 113. The tail guard 22 is connected to cover rear portions of the main frame 11 as well as at least portions of the tail support 13. As such, the tail guard 22 extends over the rear wheel 32, and functions at least in part as a mud guard to at least partially restrict the spray of mud and/or dirt and debris from the rear wheel 32. The tail guard 22 is fixedly connected to the main frame 11.

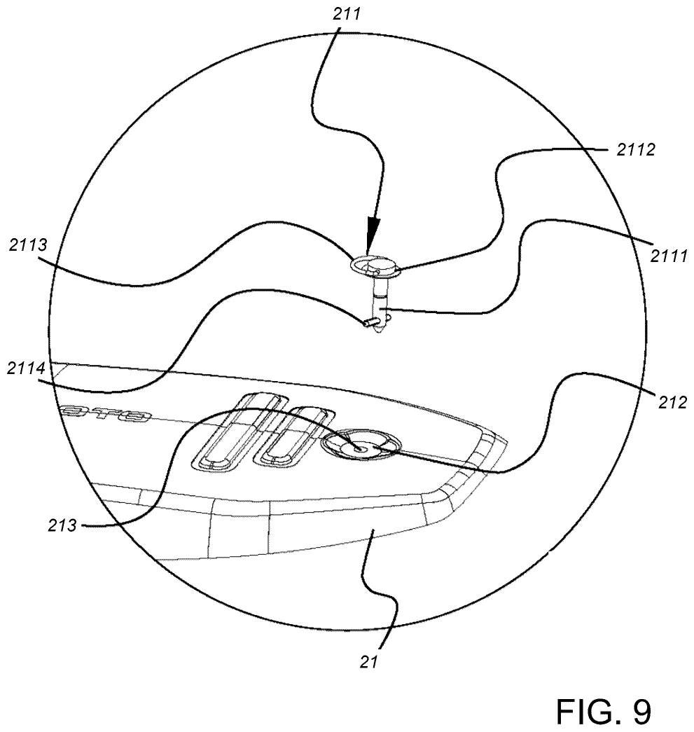

The seat 21 is detachably connected to the tail guard 22 and/or main frame 11, preferably by using one or more seat connection handbolts 211 such as shown in FIGS. 8 and 9 into a rear seat connection crossplate 115 of the main frame 11. The seat connection handbolt 211 has a threaded shaft 2111 extending from a bolthead 2112, and the bolthead 2112 is adapted to be rotated by hand without the use of tools, as well as optionally being adapted to be rotated with a tool such as a flat or Phillips screwdriver, allen wrench, hexagonal wrench or other tool. Specifically, the preferred seat connection handbolt 211 has a swing handle 2113 similar to a swing hanger bolt. The swing handle 2113 is finger pivotable from a stowage position where the swing handle 2113 is lower than the profile of a bolthead 2112, and a usage position where the swing handle 2113 extends outwardly and the user can use the swing handle 2113 to finger torque the handbolt 211 about its thread axis. The seat 21 is provided with a downwardly concave storage recess 212 to store the swing handle 2113 and the bolthead 2112, thereby avoiding interference with the driver and passengers caused by the swing handle 2113 and the bolthead 2112.

To attach the seat 21, the user first place the seat 21 on the tail guard 22 and aligns a mounting hole 213 in the seat 21 with a threaded bolt hole (not separately called out) in the rear seat connection crossplate 115. The user grasps the swing handle 2113 and rotationally advances the seat connection handbolt 211 into the rear seat connection crossplate 115 using the swing handle 2113 until the bolthead 2112 fixes the seat 21 down. The swing handle 2113 can then be pivoted downward so both the swing handle 2113 and the bolthead 2112 are within the downwardly concave storage recess 212 and beneath the profile of the seat 21. A cotter pin 2114 can then be inserted from below through the shaft 2111. The cotter pin 2114 mates with structure underneath the threaded bolt hole similar to a castle nut (not shown) to prevent the seat connection handbolt 211 from inadvertent rotational loosening such as due to vibration. Removal of the seat 21 involves the opposite procedure, first removing the cotter pin 2114 from the shaft 2111 by hand from below the tail guard 22, then using the swing handle 2113 to rotationally loosen and remove the seat connection handbolt 211. The seat 21 can thus be disassembled and installed by hand without the need for tools. The seat 21 may be fixedly connected to the tail guard 22 or directly connected to the frame 1, as long as it can achieve a fixed connection between the seat 21 and the electric motorcycle 100.

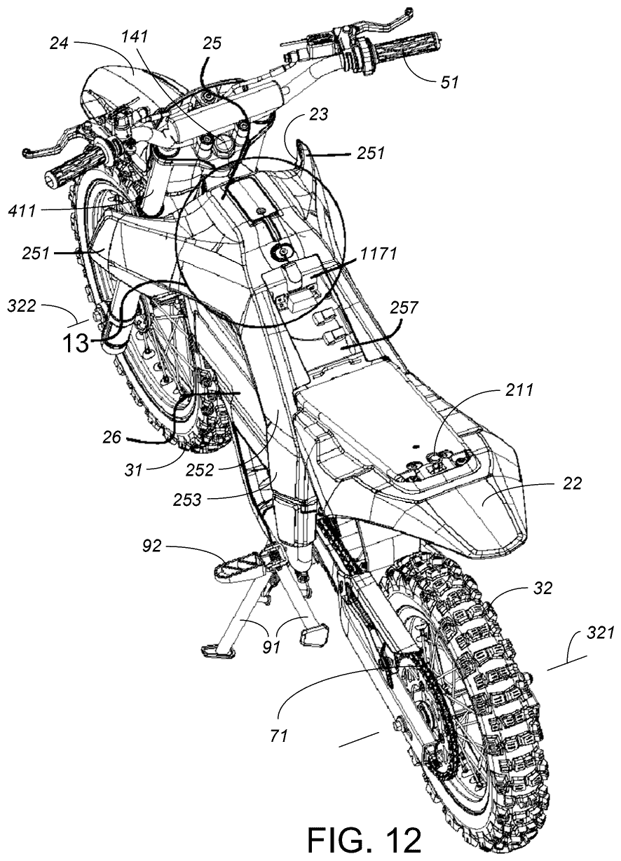

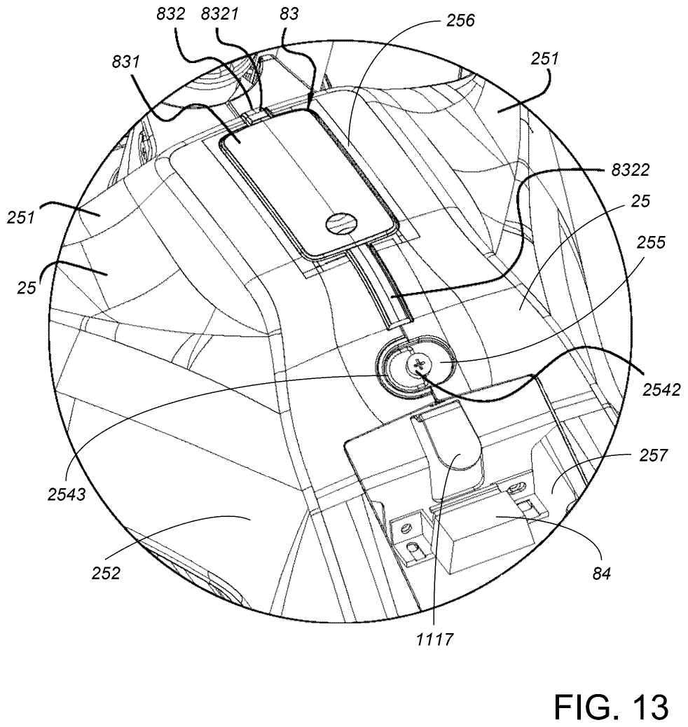

FIG. 1 shows the left front half cowl 23 as installed on the motorcycle 100, with FIGS. 12 and 13 further showing the right front half cowl 23 as installed on the motorcycle 100. The front half cowls 23 are symmetrically disposed to run from the head tube 14 outwardly, behind the front shock absorbers 411 and with a concave curvature that avoids interference with the front shock absorbers 411 during steering turning, to an air cutting outside edge 231. The air cutting outside edges 231 of the front half cowls 23 are spread wider than the front shock absorbers 411 and wider than the main frame max width W1, and preferably also wider than the frame max width W2, and most preferably the air cutting outside edges 231 are disposed wider than any portion of the motorcycle 100 other than ends of the handlebar 51. As shown in FIG. 2, the air cutting outside edge 231 of each front half cowl 23 generally lines up laterally outside the respective (left or right) front shock absorber 411. A primary purpose of the front half cowls 23 is to shield the driver's legs and body from mud, dirt and debris sprayed by the front wheel 31 and that is not caught by the front mud guard 24. The front half cowls 23 are at least partially positioned forward of the battery 81, and another purpose of the front half cowls 23 is to shield the battery 81 (and associated wire harnesses and electrical components, not separately called out) from mud, dirt and debris. The front half cowls 23 also contribute to the aesthetic appearance of the motorcycle 100.

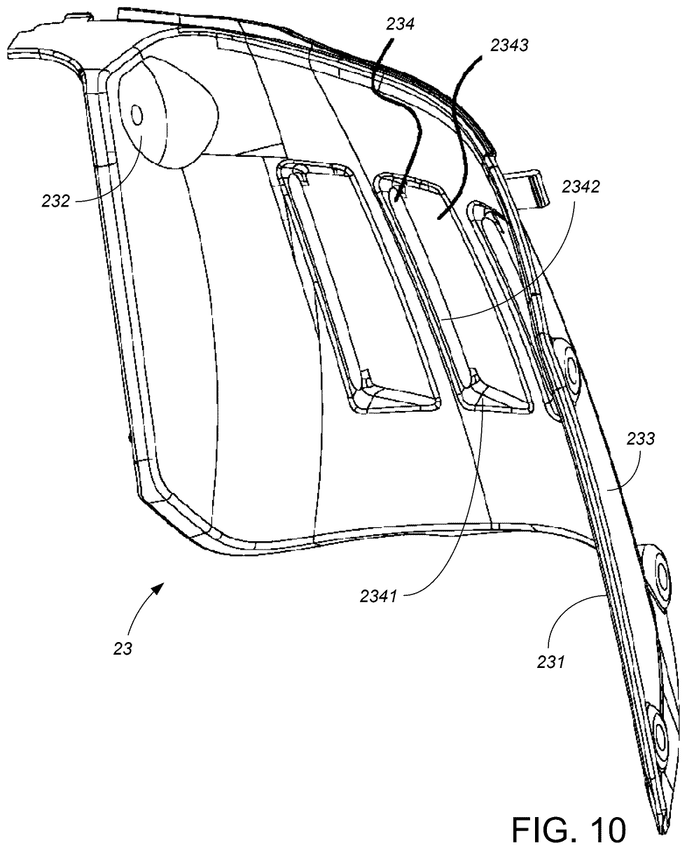

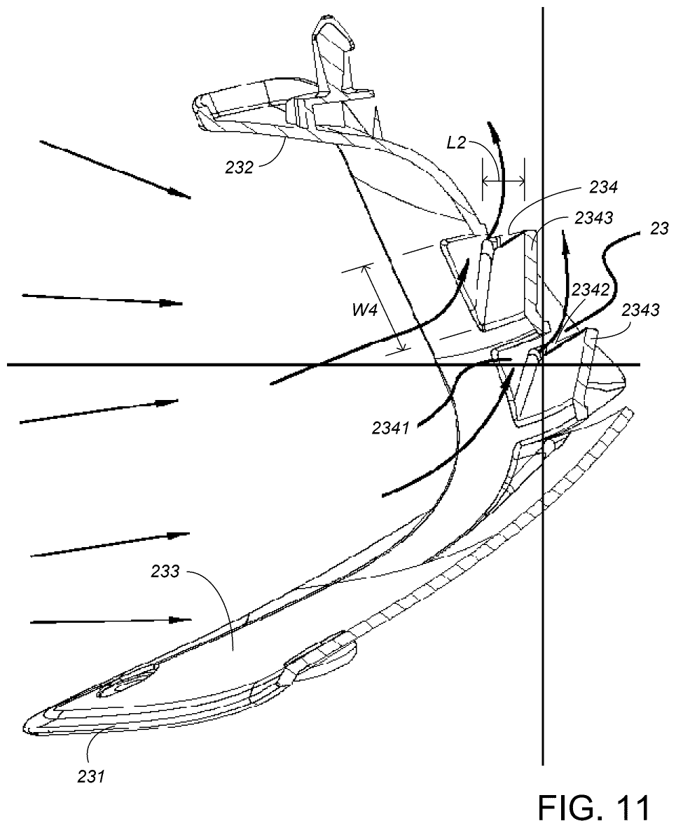

FIGS. 10 and 11 better show the left front half cowl 23 by itself. An inside portion 232 of each front half cowl 23 is adapted to be fixedly mounted to the head tube 14 and/or the main frame 11. Being considerably wider than the head tube 14, an outside portion 233 of each front half cowl 23 is adapted to be connected to the respective side guard 25.

As shown in FIGS. 10 and 11, at least two ventilation holes 234 are defined on each front half cowl 23. Other embodiments use a single ventilation hole on each front half cowl 23. The ventilation holes 234 direct air into the receiving space 15 during running of the motorcycle 100, helping to cool the battery 81 and other electrical components within the receiving space 15. The preferred ventilation holes 234 are substantially symmetrical relative to the longitudinal mid-plane S1, i.e., equally spaced in the left front half cowl 23 as in the right front half cowl 23. Each ventilation hole 234 includes an inlet 2341 and an outlet 2342 on opposing sides of an air deflection louvre 2343. The air deflection louvers 2343 are preferably sufficiently wide that the outlet 2342 does not overlap with the associated inlet 2341 in front view, such that internal structure cannot be directly observed through the ventilation holes 234 in front view. As shown by arrows in FIG. 11, air flows substantially longitudinally until it reaches the inlet 2341, with the air deflection louvre 2343 then causing the air to flow transversely inward to the outlet 2342, i.e., each outlet 2342 is disposed inwardly relative to its associated inlet 2341. Each inlet 2341 has an inlet width W4 measured along the face of the front half cowl 23, and each outlet 2342 has an outlet width L2 measured substantially in the longitudinal direction. A ventilation area ratio L2/W4 of the outlet width L2 to the inlet width W4 is preferably greater than or equal to 0.1 and less than or equal to 1, more preferably greater than or equal to 0.2 and less than or equal to 0.4. Lower values for ventilation area ratio L2/W4 cause more compression and acceleration of the airflow through the ventilation hole 234, throwing air further inwardly into the receiving space 15.

In addition to avoiding interference with the front shock absorbers 411 during turning, the concave curvature of each front half cowl 23 serves as an air scoop. During running of the motorcycle 100 at speed, air that would directly impact against the rider's knees and legs is caught by the front half cowls 23, further increasing air flow and pressure through the ventilation holes 234.

FIGS. 12 and 13 show the motorcycle 100 after the seat 21 has been removed. The preferred left and right side guards 25 are substantially symmetrical about the longitudinal mid-plane S1, with each side guard 25 having a front flare portion 251, a middle longitudinal portion 252 and a rear vertical portion 253, also shown in FIG. 2. The front flare portion 251 starts at the air cutting outside edge 231 of the respective front half cowl 23, extending inwardly and rearwardly until adjacent to the main frame 11. The front flare portion 251 essentially runs adjacent a back surface of the respective front half cowl 23, with each of the front half cowls 23 and each of the side guards 25 formed of molded sheet plastic, and with the front half cowl 23 and the respective side guard 25 supporting and strengthening each other and providing better overall connection of the vehicle cover 2 to the frame 1. Thus, the front flare portions 251 of the side guards 25 overlap at least partially with the head tube 14 in side view. Alternatively, the front flare portion 251 could be removed from the side guard 25, with the rear surface of each front half cowl 23 exposed. The middle longitudinal portion 252 runs rearwardly from the front flare portion 251 along sides of the main frame 11, extending to about the saddle dip 113 of the main frame 11. The left and right middle longitudinal portions 252 also extend over the top of the main frame 11, mating in a clam shell arrangement so as to cover the main frame 11 in plan view at least forward of the seat 21. Each rear vertical portion 253 then extends downwardly from the respective middle longitudinal portion 252 to a location adjacent the respective foot peg 92. The middle longitudinal portion 252 of each side guard 25 is at least partially mounted on the main frame 11, and the rear vertical portion 253 of each side guard 25 is preferably further at least partially mounted on the underframe 12.

In the preferred embodiment, the side guards 25 together with the tail guard 22 substantially cover the entirety of the main frame 11 in side view. However, in side view there is substantially no overlap between the side guards 25 and any of the battery 81, the motor 6, and the electronic control unit 82. Accordingly, any of the battery 81, the motor 6 and the electronic control unit 82 can be installed or disassembled from the motorcycle 100 without disassembly of either side guard 25 from the frame 1.

The side guards 25 are preferably connected to the main frame 11 using one or more sideguard handbolts 254. The sideguard handbolts 254 include a threaded shaft 2541, a bolthead 2542 and a swing handle 2543 similar to the seat connection handbolt 211. However, the sideguard handbolts 254 omit the cotter pin 2114. As shown in FIG. 12, the left and right side guards 25 each include an overlapping attachment tab 255, with a bolt hole therethrough so a single sideguard handbolt 254 can be threaded into the main frame 11 through the overlapping attachment tabs 255 of the left and right side guards 25. FIG. 13 also shows a Phillips screw bolthead 2542 for the preferred sideguard handbolt 254, in addition to the swing handle 2543. Thus, the side guards 25 can be removed or inserted by hand screwing of the sideguard handbolt(s) 254 using the swing handle 2543, or the side guards 25 can be removed using a tool such as a screwdriver to turn the sideguard handbolt(s) 254.

The electrical system 8 of the preferred electric motorcycle 100 further includes a display device 83 best shown in FIGS. 12-15. The display device 83 includes a display screen 831 and a light strip 832, both mounted so as to be bisected by the longitudinally mid-plane S1 forwardly of the seat 21 and behind the head tube 14. This positions the display screen 831 with the best viewing angle for the driver, thereby making it easier for the driver to observe the display screen 831 while driving. This also positions the display device 83 immediately adjacent a top end of the battery 81, shortening the electrical connection distance between the display device 83 and the battery 81 as much as possible.

The preferred side guards 25 each include a display device half recess 256 which receives the display device 83 so the display device 83 is at least partially mounted on the side guards 25, above the main frame 11 and facing upwardly. When both left and right side guards 25 are attached to the frame 1, the display device half recesses 256 combine to ensure the smoothness of the assembly between the display screen 831 and the outer contour of the side guards 25, and also to achieve the fastening connection between the display screen 831 and the vehicle cover 2.

Using a display area similar to a smartphone, the display screen 831 preferably shows different parameters of the electric motorcycle 100, such as battery level, vehicle operating status, vehicle mode, fault alarms, etc. Alternative embodiments do not supply the display screen 831 as part of the motorcycle thus further reducing the cost of manufacturing the motorcycle, but rather allow the user's smartphone to be mounted in the position shown by the display screen 831, communicating such as with the electronic control unit 82 or other components of the electrical system 8 via either a wired or wireless connection.

The light strip 832 emits light signals visible outside of the electric motorcycle 100 from either the right or left side of the motorcycle 100. The preferred light strip 832 includes a front light strip portion 8321 forward of the display screen 831 and a rear light strip portion 8322 extending from the display screen 831 to the seat 21. This split arrangement can present a visual effect of the light strip 832 running through the display screen 831. Other embodiments utilize a single light strip portion or more than two light strip portions. The light strip 192 preferably emits light in different colors and/or flicker states to display vehicle information. For instance, different levels of power reserve states can be represented by different preset colors. In the preferred embodiment, when the battery 81 is fully charged, the light strip 192 displays a green light signal; when the battery charge dips below a preset threshold, the light strip 192 displays a yellow light signal; and when the battery 81 is heavily discharged, the light strip 192 displays a red light signal. The power state can also or alternatively be displayed by different flashing signals. For example, the light strip 192 can emit constant light while the battery 81 is fully charged, and then start flashing at a slow speed when the battery charge dips below a preset threshold, and then flash rapidly when the battery 81 is heavily discharged. Other information such as vehicle status, vehicle gear position, and the like may also be displayed by color and flashing. Alternatively, one type of vehicle information may be displayed by color, and another type of different vehicle information may be displayed by flashing. For example, color may indicate the charge level of the battery 81, and flashing may indicate vehicle state. The vehicle information displayed by the light strip 192 may be redundant of or in addition to the content displayed by the display screen 831. The light strip 832 thus enables certain vehicle information of the electric motorcycle 100 to be amplified beyond just the display screen 831. The preferred electric motorcycle 100 is mainly intended for a youth market and off-road use, and the light strip 832 enables a non-driver to quickly obtain vehicle related information from the light strip 832 even without a clear, close-up view of the display screen 831.

As an optional embodiment, the seat 21 is provided with a profile or outline substantially continuing the line of the light strip 832. Having the seat 21 continue the line of the light strip 832 visually extends the light strip 832 to improve the overall aesthetic appearance of the electric motorcycle 100.

The preferred side guards 25 define a hollow recess 257 just rearward of the light strip 832, which after the seat 21 is attached to the motorcycle 100 is located under a front part of the seat 21. In plan view, the hollow recess 257 overlaps at least partially with the battery 81. An electrical connection port 84 for communicating with the electrical system 8 is positioned within this hollow recess 257. For instance, the electrical connection port 84 within the hollow recess 257 may be a charge port for the battery 81, or an on-board diagnostic port. Access to the electrical connection port 84 and wired communication with other components of the electrical system 8 can be achieved simply by removing the detachable seat 21, without disassembling the side guards 25. During running of the electric motorcycle 100, the seat 21 helps protect the electrical connection port 84, and also helps keeps the electrical connection port 84 dry against precipitation.

The left and right battery guards 26 are at least partially arranged on the underframe 12, under the middle longitudinal portion 252 and in front of the rear vertical portion 253 of the respective side guard 25. At least portions of the edges of each battery guard 26 are stored inside the respective side guard 25, thereby forming a relatively fixed relationship between the battery guard 26 and the respective side guard 25, and also helping to conceal connections between the battery guard 26 and the frame 1. The battery guards 26 are relatively flat plate-like panels that cover at least a majority (i.e., >50%) and more preferably all of the two major sides 811 of the battery 81. The battery guards 26 also preferably cover the battery support system 93, which not only looks beautiful but helps prevent malicious disassembly of the battery 81. The battery guards 26 can also thermally insulate the battery 81, helping to prevent low-temperature power failure in cold climates. In the preferred embodiment, the battery guards 26 are mounted from the battery support system 93, which is beneficial for reducing the number of assembly points into the frame 1.

The battery guards 26 preferably do not extend so low as to cover the motor 6 and/or the electronic control unit 82. In side view, the motor 6 and/or the electronic control unit 82 are preferably visible below the battery guard 26. Thus, neither the battery guards 26 nor the side guards 25 interfere with air flow and heat dissipation around the motor 6 and/or electronic control unit 82.

As a preferred embodiment, the battery guards 26 are transparent or translucent. The preferred battery guards 26 are made of a material of PP (polypropylene polymer). The light transmittance of the battery guards 26 is preferably greater than or equal to 0 and less than or equal to 30%, and most preferably 20%. Use of transparent or translucent battery guards 26 allows better viewing and monitoring of the battery 81 without disassembling the vehicle cover 2. If the battery 81 sustains visible damage, such visible damage can be quickly observed by viewing through the preferred battery guards 26, which can lead to more timely maintenance and/or repair of the battery 81. In other embodiments, the battery guards may be opaque.

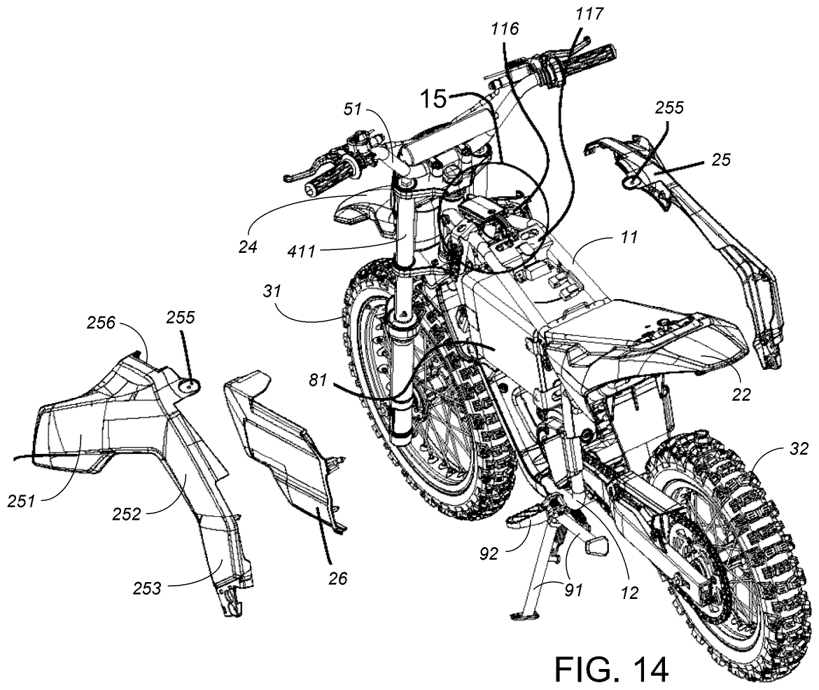

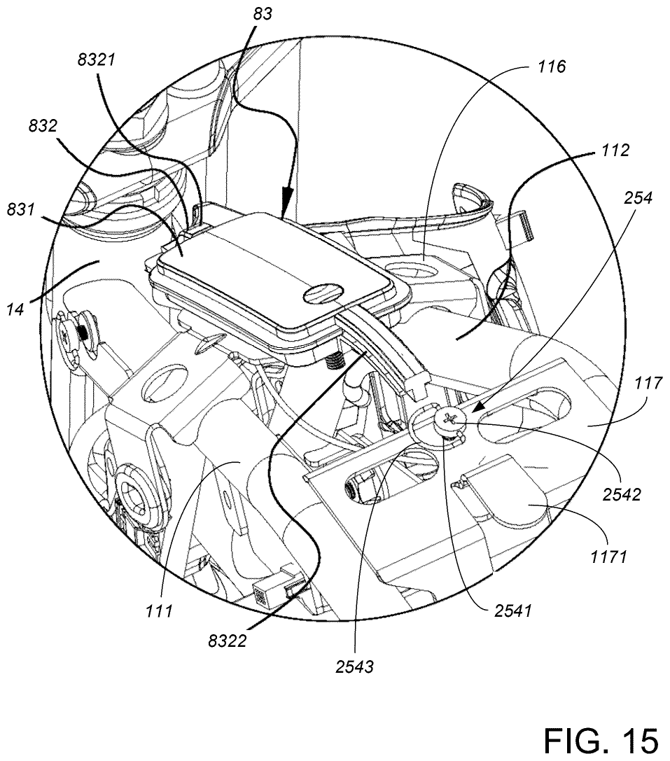

FIGS. 14 and 15 show exploded views of the side guards 25 and battery guards 26. A display support crossplate 116 is attached so as to run transversely from the top of the left main frame tube 111 to the top of the right main frame tube 112, just rearward of the head tube 14. The display screen 831 is at least partially positioned on the display support crossplate 116, preferably being fixedly connected to the display support crossplate 116. The preferred display support crossplate 116 is a sheet metal part, but alternative embodiments use a tube or a forged part, as long as it can achieve the connection and fixation of the display device 83.

A front seat connection crossplate 117 is attached so as to run transversely from the top of the left main frame tube 111 to the top of the right main frame tube 112, spaced rearwardly from the display support crossplate 117. The front seat connection crossplate 117 provides a front seat latch hook 1171, for securing the front of the seat 21 in conjunction with the seat connection handbolt 211 securing the rear of the seat 21. At least one sideguard handbolt 254 for securing the side guards 25 can be threaded into the front seat connection crossplate 117.

It should be understood that the specific embodiments described herein are only for explaining the present application and not for defining it. In accordance with the embodiments provided by the present application, all other embodiments obtained by a person skilled in the art without performing creative work belong to the protection scope of the present application.

Obviously, the drawings are only some examples or embodiments of the present application, and for those skilled in the art, the present application may also be applicable to other similar situations according to the drawings, without creative labor. Further, it is to be understood that although the work done in this development process may be complex and lengthy, for a person of ordinary skill in the art, some design, manufacturing or production changes according to the technical contents disclosed in the present application are only conventional technical means, and should not be considered as insufficient contents disclosed in the present application.

The above embodiments only express several embodiments of the present application, the description of which is more specific and detailed, but cannot be construed as a limitation on the scope of patent protection. It should be noted that, for those skilled in the art, on the premise of not departing from the concept of the present application, a plurality of deformations and improvements may be made, which are all within the protection scope of the present application. Therefore, the scope of protection of the present application shall be subject to the attached claims.

1. An electric motorcycle, comprising
a frame comprising a main frame extending longitudinally and an underframe at least partially positioned below the main frame, the main frame and the underframe jointly defining a receiving space between the main frame and the underframe;
a vehicle cover at least partially covering the frame;
wheels comprising a front wheel and a rear wheel with a distance between a front wheel rotational axis and a rear wheel rotational axis being defined as a wheelbase, the wheels supporting the frame through a suspension system;
an electric motor providing torque to at least one of the front wheel or the rear wheel, the electric motor being supported by the frame within the receiving space;
a battery supported by the frame within the receiving space and providing electrical energy for the motor; and
an electronic control unit for controlling the motor, the electronic control unit being supported by the frame within the receiving space so as to be transversely in line with at least part of the electric motor;
wherein a combined width ratio of a combined width of the electric motor and electronic control unit divided by a maximum width of the frame is greater than or equal to 0.55 and less than or equal to 0.75; and
wherein a frame width ratio of the maximum width of the main frame divided by the wheelbase is greater than or equal to 0.08 and less than or equal to 0.15.

2. The electric motorcycle of claim 1, wherein the motor has a motor shaft axis extending transversely, wherein a motor position line is defined to run between the front wheel rotational axis and the motor shaft axis, and wherein a motor elevation angle between the motor position line and horizontal, taken when the suspension system is unloaded on flat ground, is greater than or equal to 10° and less than or equal to 20°.

3. The electric motorcycle of claim 1, wherein the front wheel has a front wheel diameter and the rear wheel has a rear wheel diameter, wherein the front wheel diameter is greater than the rear wheel diameter.

4. The electric motorcycle of claim 1, wherein the maximum width of the main frame is narrower than the maximum width of the frame.

5. The electric motorcycle of claim 1, wherein the battery has a rectangular prism shape with a battery width, wherein the battery width extends no more than the maximum width of the main frame, and wherein the battery width is less than the maximum width of the frame, and wherein the maximum width of the frame occurs on the underframe adjacent footpegs.

6. The electric motorcycle of claim 1, wherein the frame further comprises a tail support and a head tube, wherein the main frame comprises a left main frame tube connected to the head tube and extending rearwardly therefrom and a right main frame tube connected to the head tube and extending rearwardly therefrom, each of the left main frame tube and the right main frame tube having a center section defining a saddle dip, wherein the underframe comprises a left underframe tube and a right underframe tube, each of the left underframe tube and the right underframe tube being connected to the center section of the main frame at or adjacent the saddle dip, and wherein the tail support comprises a left tail support tube and a right tail support tube, each of the left tail support tube and right tail support tube having front ends connected to the underframe and rear ends connected to the main frame.

7. The electric motorcycle of claim 1, further comprising a battery support system having fixed portions and a detachable side strap, wherein the fixed portions of the battery support system limit movement of the battery in front, back, up, and down directions, as well as one of left or right directions, and wherein the detachable side strap limits movement of the battery in the other of the left or right directions.

8. The electric motorcycle of claim 7, wherein the vehicle cover comprises left and right front half cowls and left and right side guards, each of the side guards comprising a front flare portion, a middle longitudinal portion and a rear vertical portion, the front flare portion of each of the side guards being connected to the respective front half cowl at a location wider than the maximum width of the frame, each of the middle longitudinal portions being connected to the main frame, wherein the battery can be removed from the receiving space without removing the side guards from the frame.

9. The electric motorcycle of claim 1, further comprising a seat detachably connected relative to the frame using one or more seat connection handbolts.

10. The electric motorcycle of claim 9, wherein the seat connection handbolt comprises a bolthead and a threaded shaft, with a swing handle pivotally connected to the bolthead.

11. The electric motorcycle of claim 1, wherein frame comprises a head tube and wherein the suspension system comprises two front shock absorbers connected to the front wheel, the two front shock absorbers being pivotal about a head tube axis for steering of the front wheel, wherein the vehicle cover comprises left and right front half cowls, each of the front half cowls having an air cutting outside edge disposed wider than the front shock absorbers and wider than the maximum width of the frame.

12. The electric motorcycle of claim 11, wherein each of the front half cowls comprises at least one ventilation hole allowing airflow therethrough to the receiving space.

13. The electric motorcycle of claim 1, further comprising a display device having a display screen and a light strip, wherein the light strip provide vehicle information via either change of color of light emitted from the light strip or change in flashing pattern of light emitted from the light strip.

14. The electric motorcycle of claim 13, wherein the vehicle information provided by the light strip comprises battery charge information.

15. The electric motorcycle of claim 1, wherein the vehicle cover comprises at least one guard connected to the frame using at least one handbolt.

16. An electric motorcycle comprising:
a frame comprising a main frame extending longitudinally rearwardly from a head tube and an underframe at least partially positioned below the main frame, the main frame and the underframe jointly defining a receiving space between the main frame and the underframe, the frame having a maximum frame width;
a vehicle cover at least partially covering the frame;
wheels comprising a front wheel and a rear wheel;
a suspension system connected to the wheels and supporting the frame, wherein the suspension system comprises two front shock absorbers connected to the front wheel, the two front shock absorbers being pivotal about a head tube axis for steering of the front wheel;
an electric motor providing torque to at least one of the front wheel or the rear wheel, the electric motor being supported by the frame within the receiving space; and
a battery supported by the frame within the receiving space and providing electrical energy for the motor;
wherein the vehicle cover comprises left and right front half cowls disposed on left and right sides of the head tube behind the front shock absorbers, each of the front half cowls having an air cutting outside edge disposed wider than the front shock absorbers and wider than the maximum frame width.

17. The electric motorcycle of claim 16, wherein the vehicle cover further comprises left and right side guards, each of the side guards comprising a front flare portion, a middle longitudinal portion and a rear vertical portion, the front flare portion of each of the side guards being connected to the respective front half cowl at a location wider than the maximum frame width, each of the middle longitudinal portions being connected to the main frame, wherein the battery can be removed from the receiving space without removing the side guards from the frame.

18. The electric motorcycle of claim 16, wherein the vehicle cover further comprises left and right battery guards covering respective left and right major sides of the battery, wherein the battery guards are formed of a polymer which is transparent or translucent to allow viewing of the battery therethrough.

19. An electric motorcycle comprising:
a frame comprising a main frame extending longitudinally rearwardly from a head tube and an underframe at least partially positioned below the main frame, the underframe comprising a left underframe tube and a right underframe tube, the main frame and the underframe jointly defining a receiving space between the main frame and the underframe, the main frame having a maximum main frame width, the frame having a maximum frame width defined by the left underframe tube and the right underframe tube, the maximum frame width being larger than the maximum main frame width;
a vehicle cover at least partially covering the frame;
wheels comprising a front wheel and a rear wheel with a distance between a front wheel rotational axis and a rear wheel rotational axis being defined as a wheelbase, the wheels supporting the frame through a suspension system;
an electric motor providing torque to at least one of the front wheel or the rear wheel, the electric motor being supported by the frame within the receiving space;
a battery supported by the frame within the receiving space and providing electrical energy for the motor; and
a battery support system having fixed portions and a detachable side strap, wherein the fixed portions of the battery support system limit movement of the battery in front, back, up, and down directions, as well as one of left or right directions, and wherein the detachable side strap limits movement of the battery in the other of the left or right directions.

20. The electric motorcycle of claim 19, wherein the battery has a rectangular prism shape with a battery width, wherein the battery width extends no more than 10 mm beyond the maximum main frame width, and wherein the battery width is less than the maximum frame width.
